(19) United States
(12) Patent Application Publication
(10) Pub. No.: US 2005/0142362 A1
(43) Pub. Date: Jun. 30, 2005

(54) Hard coat film

(75) Inventors: Osamu Inaoka, Saitama-shi (JP); Satoru Shoshi, Koshigaya-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: LINTEC CORPORATION, Tokyo (JP)

(21) Appl. No.: 11/005,865

(22) Filed: Dec. 6, 2004

(30) Foreign Application Priority Data
Dec. 26, 2003 (JP) 2003-434428

(51) Int. Cl. B32B 27/18; B32B 27/38; B32B 27/36; B32B 27/30; B32B 27/40

(52) U.S. Cl. 428/411.1; 428/413; 428/423.1; 428/482; 428/522

(57) ABSTRACT

A hard coat film exhibits excellent scratch resistance and wear resistance, provides the property for preventing attachment of finger prints and the property for removal of finger prints by a simple operation, is excellent in retaining these properties, exhibits excellent solvent resistance and is advantageously used as the hard coat film for touch panels and the hard coat film for protecting various types of display. The hard coat film comprises a transparent substrate film and a hard coat layer disposed at least on one face of the substrate film, wherein the hard coat layer comprises a cured product of a resin composition sensitive to an ionizing radiation which comprises a polymerizable surfactant.

### BACKGROUND OF THE INVENTION

1. Field of the Invention

The present invention relates to a hard coat film and, more particularly, to a hard coat film which suppresses attachment of finger prints, enables easy wiping out of attached finger prints, is excellent in retaining these properties, exhibits excellent solvent resistance and is advantageously used as the hard coat film for touch panels and the hard coat film for protecting various types of display.

2. Description of Related Art

Transparent hard coat films have heretofore been used for protection of surfaces and prevention of glare and reflection in various image display devices such as LCD (liquid crystal displays), touch panels, CRT (cathode ray tubes), PDP (plasma display panels), EL (electroluminescence displays) and optical disks.

Touch panels are used as the input apparatus for portable information terminals which are being widely used in recent years. The touch panel is an apparatus for inputting data by directly touching the surface of a display by a finger or a pen.

About 90 percent of the entire touch panels are the touch panels of the resistance film type. The touch panel of the resistance film type has, in general, a structure in which a transparent plastic substrate of the touching side which has a transparent electrically conductive (referred to as “conductive”, hereinafter) thin film such as a film of indium oxide doped with tin (ITO) laminated on one face of a transparent plastic substrate material and a transparent substrate of the display side which has a transparent conductive thin film such as an ITO film laminated on one face of a transparent substrate material such as a glass plate are arranged via an insulating spacer placed between the two substrates in a manner such that the transparent conductive thin films on the two substrates are faced to each other.

For the input operation, the face for input by touching (the face opposite to the face having the transparent conductive thin film) of the plastic substrate of the touching side is pressed by a pen or a finger, and the transparent conductive thin film of the transparent plastic substrate of the touching side and the transparent conductive thin film of the transparent substrate of the display side are brought into contact with each other.

However, the touch panel of the resistance film type has a problem in that the transparent conductive thin film on the transparent plastic substrate of the touching side is worn, has cracks or is separated from the substrate material after repeated input operations, i.e., after the transparent conductive thin film of the transparent plastic substrate of the touching side and the transparent conductive film of the transparent substrate of the display side are repeatedly brought into contact with each other. To overcome the above problem, it is widely conducted that a hard coat layer of a cured resin is disposed between the transparent plastic substrate material and the transparent conductive thin film. It is also widely conducted that a hard coat layer is disposed on the surface of the transparent plastic substrate material opposite to the surface on which the transparent conductive thin film is disposed.

FIG. 1 shows a schematic diagram exhibiting a sectional view of an example of the structure of a conventional touch panel of the resistance film type. A touch panel of the resistance film type 10 has a transparent plastic substrate A which has a transparent plastic substrate material 1, hard coat layers 2 and 2′ disposed on both faces of the substrate material 1 and a transparent conductive thin film 3 laminated on the hard coat layer 2′ on the back face of the substrate material and a transparent substrate B which has a transparent substrate material 4 and a transparent conductive thin film 3′ laminated on one face of the substrate material 4. The transparent plastic substrate A of the touching side and the transparent substrate B of the display side are arranged via spacers 5 in a manner such that the transparent conductive thin film 3 of the transparent plastic substrate A and the transparent conductive thin film 3′ of the transparent substrate B are faced to each other.

In the touch panel having the above structure, a hard coat film having hard coat layers disposed on one or both faces of the transparent plastic substrate material is used.

When a display such as PDP, CRT, LCD and EL is used, light from the outside is occasionally reflected at the surface of the display, and difficulty arises in watching images on the display. In particular, as the size of flat panel displays increases recently, overcoming the above problem is becoming more important.

To overcome the above problem, various treatments for preventing glare and reflection of light have been made on various display devices. As one of such treatments, it is conducted, for example, that the function of preventing glare and reflection of light is provided for protective films used in various displays. For the above protective films used in displays, the properties as the hard coat, i.e., scratch resistance and wear resistance of the surface, are required in combination with the above functions.

For preparation of the film for preventing reflection of light, when a dry process such as vapor deposition and sputtering is used, a thin film of a substance having a low refractive index such as MgF₂ is formed on a substrate film material, or layers of a substance having a high refractive index such as ITO and TiO₂ and layers of a substance having a low refractive index such as MgF₂ and SiO₂ are alternately laminated on a substrate film material. However, the film for preventing reflection of light prepared in accordance with the dry process has a problem in that the cost of production is inevitably expensive.

Recently, it is attempted that a hard coat film having the property for preventing reflection of light is prepared in accordance with a wet process, i.e., the coating process. In the wet process, for example, a film of an acrylic resin exhibiting excellent weatherability is used as the substrate material. After a layer of a cured layer of a resin composition sensitive to an ionizing radiation is formed, the film is treated for preventing reflection of light and used as the protective film for liquid crystal display devices of portable telephones, personal digital assistant (PDA) and video cameras.

Hard coat films for touch panels and hard coat films for protecting displays have drawbacks in that dirt and finger prints are easily attached to the surface of the hard coat layer of the films since these films are disposed at the outermost face of the products.

To provide the property for preventing attachment of dirt and the property for removing dirt, it is conducted that a silicone-based compound or a fluorine-based compound is introduced into the hard coat layer so that the surface of the hard coat layer has the property of repelling water. However, this method has a problem in that the property for preventing attachment of finger prints and the property for removing finger prints are not always satisfactory, and finger prints are occasionally more easily attached (are seen more distinctly) although this method is effective for preventing attachment of ordinary household substances such as dirt, dusts, foods and cosmetics. This method has another problem in that, when the surface is wiped with a finger or tissue paper to remove the attached finger prints, substances forming the finger prints are mixed with the silicone-based compound or the fluorine-based compound used as the additive, and loci of the wiping tend to remain.

As the hard coat film provided with the property for wiping out finger prints, for example, a plastic film in which a plastic substrate material is coated with a hard coat film containing silica having a surface treatment, an acrylate and a photopolymerization initiator, is disclosed (for example, Japanese Patent Application Laid-Open No. 2000-293895). In this technology, colloidal silica having a particle diameter smaller than 1 μm and having a surface treatment with a silyl acrylate such as γ-methacryloxypropyltrimethoxysilane is used as the silica. However, this technology has problems in that the silica having the surface treatment is expensive and that the effect of providing the anti-glare property cannot be expected in applications requiring silica having a relatively great particle diameter (an average particle diameter of about 1 to 30 μm) such as the application in which the anti-glare property is provided to hard coat films.

The present inventors intensively studied the property for preventing attachment of finger prints on hard coat layers and the property for wiping out the attached finger prints. Based on considerations that polyorganosiloxane-based leveling agents which are widely used adversely affected the property for wiping out finger prints and that nonionic surfactants having the hydrophile-lypophile balance (HLB) in a specific range could improve the property for preventing attachment of finger prints, it was found that a hard coat film exhibiting excellent property for preventing attachment of finger prints and the excellent property for wiping out the attached finger prints could be obtained by adding the above nonionic surfactant in a specific relative amount and, preferably, without adding polyorganosiloxane-based leveling agents (Japanese Patent Application No. 2002-277695).

However, the retention of the property for preventing attachment of finger prints with the nonionic surfactant is not always satisfactory.

### SUMMARY OF THE INVENTION

Under the above circumstances, the present invention has an object of providing a hard coat film which exhibits excellent scratch resistance and wear resistance, provides the property for preventing attachment of finger prints and the property for removal of finger prints by a simple operation, is excellent in retaining these properties, exhibits excellent solvent resistance and is advantageously used as the hard coat film for touch panels and the hard coat film for protecting various types of display.

As the result of intensive studies by the present inventors to develop the hard coat film having the above excellent functions, it was found that the object could be achieved by disposing at least one face of a transparent substrate material film a hard coat layer obtained by curing a resin composition sensitive to ionizing radiation containing a polymerizable surfactant and, preferably, fine particles. The present invention has been completed based on this knowledge.

The present invention provides:
(1) A hard coat film comprising a transparent substrate material film and a hard coat layer disposed at least on one face of the substrate material film, wherein the hard coat layer comprises a cured product of a resin composition sensitive to an ionizing radiation which comprises a resin component curable with an inonizing radiation and a polymerizable surfactant;
(2) The hard coat film according to (1), wherein the polymerizable surfactant is at least one surfactant selected from the group consisting of an anionic surfactant and a nonionic surfactant, each surfactant having a radical polymerizable functional group in a molecule;
(3) The hard coat film according to (2), wherein the polymerizable surfactant is an anionic surfactant comprising a sulfuric acid ester salt;
(4) The hard coat film according to any one of (1) to (3), wherein a content of the polymerizable surfactant in the resin composition sensitive to an ionizing radiation is 0.1 to 15 parts by weight per 100 parts by weight of the resin component curable with an ionizing radiation;
(5) The hard coat film according to any one of (1) to (4), wherein the hard coat layer comprises 0.1 to 60% by weight of fine particles having an average diameter of 0.005 to 30 μm; and
(6) The hard coat film according to any one of (1) to (5), which is used for touch panels.

### BRIEF DESCRIPTION OF THE DRAWINGS

FIG. 1 shows a schematic diagram exhibiting a sectional view of an example of the structure of a conventional touch panel of the resistance film type.

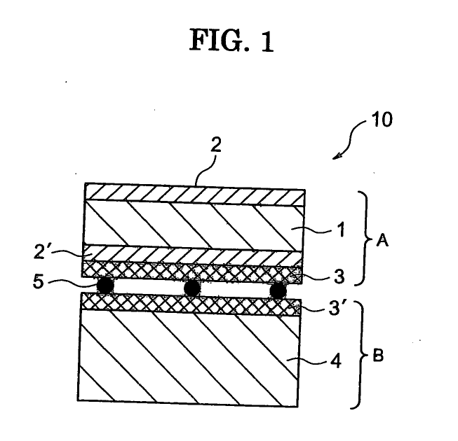

The numbers and characters in the figures have the meanings as listed in the following:
1: A transparent plastic substrate material
2,2′: Hard coat layers
3,3: Transparent conductive thin films
4: A transparent substrate material
5: A spacer
10: A touch panel of the resistance film type
A: A transparent plastic substrate of the touching side
B: A transparent substrate of the display side

### DESCRIPTION OF THE PREFERRED EMBODIMENTS

The hard coat film of the present invention is a laminate film comprising a hard coat layer which comprises a cured product of a resin composition sensitive to an ionizing radiation and is disposed at least on one face of a transparent substrate material film.

The transparent substrate material film in the hard coat film of the present invention is not particularly limited, and a suitable film can be selected from conventional plastic films used heretofore as the substrate material in hard coat films for optical applications. Examples of the plastic film include polyester-based films such as polyethylene terephthalate films, polybutylene terephthalate films, polyethylene naphthalate films and polycarbonate films; acrylic films such as polymethyl methacrylate films; polyolefin-based films such as polyethylene films, polypropylene films, polymethylpentene films and films of polymers having an alicyclic structure; cellophane; diacetylcellulose films; triacetylcellulose films; acetylcellulose butyrate films; polyvinyl chloride films; polyvinylidene chloride films; polyvinyl alcohol films, ethylene-vinyl acetate copolymer films; polystyrene films; polysulfone films; polyether ether ketone films; polyether sulfone films; polyether imide films; polyimide films; fluororesin films; and polyamide films.

Among these transparent substrate material films, the polyester-based films, the acrylic films and the polyolefin-based films are preferable as the substrate material of films for optical applications such as films for touch panels and films for protecting the surface of various displays from the standpoint of the properties and the economy. For applications requiring heat resistance, polyolefin-based films having an alicyclic structure are preferable.

The substrate material film may be transparent or translucent and colored or colorless and can be suitably selected in accordance with the application. For example, a colorless transparent film is preferable when the film is used for protection of liquid crystal display devices.

The thickness of the transparent substrate material film is not particularly limited and suitably selected in accordance with the situation. In general, the thickness is in the range of 15 to 300 μm and preferably in the range of 30 to 250 μm. One or both faces of the transparent substrate material film may be subjected to various treatments such as the oxidation treatments and the roughening treatments, where desired, so that adhesion with layers disposed on the surfaces is enhanced. Examples of the oxidation treatment include the treatment by corona discharge, the treatment with plasma, the treatment with chromic acid (a wet process), the treatment with flame, the treatment with heated air or irradiation with ultraviolet light in the presence of ozone. Examples of the roughening treatment include the sandblasting treatment and the treatments with solvents. The surface treatment is suitably selected in accordance with the type of the transparent substrate material film. In general, the treatment by corona discharge is preferable from the standpoint of the effect and the easiness of treatment. The surface may be treated with a primer.

In the hard coat film of the present invention, a hard coat layer comprising a cured product of a resin composition sensitive to an ionizing radiation comprising a polymerizable surfactant is disposed at least on one face of the transparent substrate material film.

The polymerizable surfactant comprised in the resin composition sensitive to an ionizing radiation described above is not particularly limited as long as the surfactant can be polymerized by irradiation with an ionizing radiation. For example, anionic and nonionic surfactants having a radical polymerizable functional group in the molecule are preferable from the standpoint of the effect.

Examples of the radical polymerizable anionic surfactant among the polymerizable surfactants include surfactants represented by the following general formulae [1], [2], [3a], [3b] and [4]: 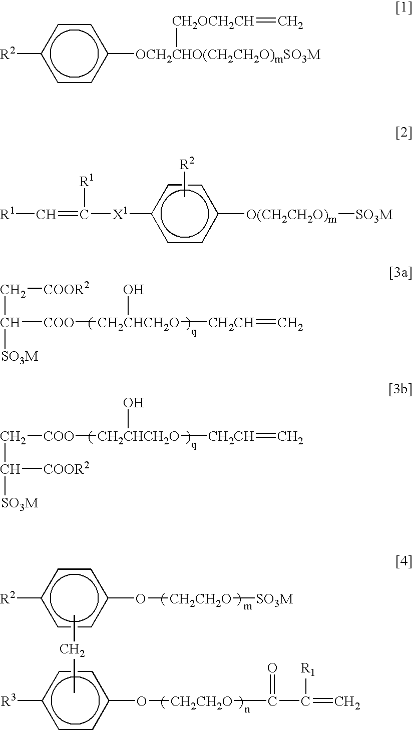
wherein R¹ represents a hydrogen atom or a methyl group, R² and R³ each represent an alkyl group, an alkenyl group, an aryl group or an aralkyl group each having 6 to 18 carbon atoms, X¹ represents a single bond or a methylene group, M represents an alkali metal, ammonium group or an organic ammonium group, m and n each represent an integer of 1 to 50, and q represents a number of 0 or 1.

Examples of the surfactant represented by general formula [1] include “ADEKA REASOAP SE-10N”, “ADEKA REASOAP SE-20N” and “ADEKA REASOAP SE-30N”(all trade names; manufactured by ASAHI DENKA KOGYO Co., Ltd.). Examples of the surfactant represented by general formula [2] include “AQUALON HS-05”, “AQUALON HS-10”, “AQUALON HS-20” and “AQUALON HS-30” (all trade names; manufactured by DAIICHI KOGYO SEIYAKU Co., Ltd.). Examples of the surfactant represented by general formula [3] include “LATEMUL S-120”, “LATEMUL S-120A”, “LATEMUL S-180” and “LATEMUL S-180A” (all trade names; manufactured by KAO Co., Ltd.) and “ELEMINOL JS-2” (a trade name; manufactured by SAN-YO KASEI KOGYO Co., Ltd.). Examples of the surfactant represented by general formula [4] include “ANTOX HS-60” (a trade name; manufactured by NIPPON NYUKAZAI Co., Ltd.).

Examples of the radical polymerizable anionic surfactant other than those described above include alkylalkenyl succinic acid ester salt-based polymerizable surfactants such as “LATEMUL ASK” (a trade name; manufactured by KAO Co., Ltd.), polyoxyalkylene (meth)acrylate sulfuric acid ester salt-based polymerizable surfactants such as “ELEMINOL RS-30” (a trade name; manufactured by SAN-YO KASEI KOGYO Co., Ltd.), polyoxyalkylene alkyl ether aliphatic unsaturated dicarboxylic acid ester salt-based polymerizable surfactants such as “RA-1120” and “RA-2614” (both trade names; manufactured by NIPPON NYUKAZAI Co., Ltd.), (meth)acrylic acid sulfoalkyl ester salt-based polymerizable surfactants such as “ANTOX HS-2N” (a trade name; manufactured by NIPPON NYUKAZAI Co., Ltd.), phthalic acid dihydroxyalkyl (meth)acrylate sulfuric acid ester salt-based polymerizable surfactants, and mono- and di(glycerol-1-alkylphenyl-3-allyl-2-polyoxy-alkylene ether) phosphoric acid ester salt-based polymerizable surfactants such as “H3330PL” (a trade name; manufactured by DAIICHI KOGYO SEIYAKU Co., Ltd.).

Further examples of the polymerizable surfactant include polymerizable anionic surfactants having fluorine which are represented by general formula [5]: 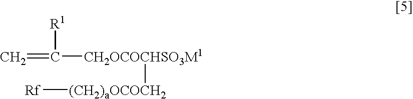
wherein R¹ represents a hydrogen atom or a methyl group, Rf represents a fluoroalkyl group having 1 to 20 carbon atoms which may have hydrogen atom and chlorine atom, M¹ represents an alkali metal, and a represents an integer of 1 to 6, which are disclosed in Japanese Patent Application Laid-Open No. Heisei 10(1998)-245370.

In general formula [5], the group represented by Rf has 1 to 20 carbon atoms, preferably 1 to 10 carbon atoms and more preferably 4 to 6 carbon atoms. Examples of the group represented by Rf include perfluoroalkyl groups such as CF₃(CF₂)₃—, CF₃(CF₂)₅—, CF₃(CF₂)₇— and CF₃(CF₂)₉—; and fluoroalkyl groups in which the ω-position is substituted with one hydrogen atom such as H(CF₂)₂—, H(CF₂)₄—, H(CF₂)₆—, H(CH₂)₈— and H(CF₂)₁₀—.

Examples of the radical polymerizable nonionic surfactant include surfactants represented by following general formulae [6] and [7]: 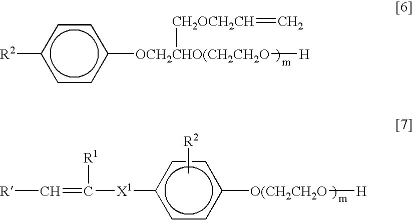
wherein R¹, R², X¹ and m are as defined for general formulae [1] to [4].

Examples of the surfactant represented by general formula [6] include “ADEKA REASOAP NE-10”, “ADEKA REASOAP NE-20”, “ADEKA REASOAP NE-30” and “ADEKA REASOAP NE-40” (all trade names; manufactured by ASAHI DENKA KOGYO Co., Ltd.). Examples of the surfactant represented by general formula [7] include “AQUALON RN-10”, “AQUALON RN-20”, “AQUALON RN-30” and “AQUALON RN-50” (all trade names; manufactured by DAIICHI KOGYO SEIYAKU Co., Ltd.).

Examples of the radical polymerizable nonionic surfactants other than those described above include polyoxyalkylene alkylphenyl ether (meth)acrylate-based polymerizable surfactants such as “RMA-564”, “RMA-568” and “RMA-1114” (all trade names; manufactured by NIPPON NYUKAZAI Co., Ltd.).

In the present invention, the radical polymerizable anionic and nonionic surfactants may be used singly or in combination of two or more. Among these surfactants, anionic surfactants comprising a sulfuric acid ester salt are preferable from the standpoint of the effect of preventing attachment of finger prints.

Since the resin composition sensitive to an ionizing radiation contains the polymerizable surfactant, copolymerization between the resin component curable with an ionizing radiation and the polymerizable surfactant takes place during curing of the resin composition, and the component having the surface active ability is introduced into the molecule of the cured resin. As the result, the property for preventing attachment of finger prints and the property for removing the attached finger prints are provided to the hard coat layer, and the retention of these properties and the solvent resistance are improved.

In the present invention, it is preferable that the polymerizable surfactant is used in an amount in the range of 0.1 to 15 parts by weight per 100 parts by weight of the resin component curable with an ionizing radiation in the resin composition. When the amount of the polymerizable surfactant is within the above range, the excellent property for preventing attachment of finger prints and the excellent property for removing the attached finger prints can be exhibited, and the hard coating property can be retained. It is more preferable that the amount of the polymerizable surfactant is in the range of 0.5 to 10 parts by weight and most preferably in the range of 1 to 7 parts by weight.

In the hard coat film of the present invention, the hard coat layer may comprise various fine particles, where necessary.

The fine particles can be suitably selected from particles having an average diameters in the wide range of 0.005 to 30 μm in accordance with the function required for the hard coat layer such as the desired refractive index, the anti-glare property, the property for preventing reflection of light, the clarity of vision, the small shrinkage and the small curling. The content of the fine particles in the hard coat layer is suitably selected in the wide range of 0.1 to 60% by weight in accordance with the above function required for the hard coat layer.

The fine particles can be approximately divided into silica-based particles and other metal oxide-based particles. First, the silica-based particles will be described in the following.

As the silica-based fine particles, silica sol having an average diameter of about 0.005 to 1 μm, fine particles of silica and fine particles of silicone resins having an average diameter of about 0.1 to 10 μm and aggregates of colloidal fine particles of silica with an amine having an average diameter of about 0.3 to 30 μm, can be used.

The silica sol can be used to provide the hard coat layer with a small refractive index, a small shrinkage (a small shrinkage by curing and a small shrinkage under heat and moisture) and a small curling. As the silica sol, colloidal silica in which fine particles of silica having an average diameter of about 0.005 to 1 μm are colloidally suspended in an organic solvent such as an alcohol-based solvent or a cellosolve-based solvent is preferable.

As the silica sol, a reactive silica sol obtained by reacting silanol group on the surface of the colloidal silica particles with an organic compound having a radical polymerizable unsaturated group and a functional group reactive with the silanol group can be used. The reactive silica sol may be used singly or in combination of two or more.

Preferable examples of the organic compound having a radical polymerizable unsaturated group and a functional group reactive with the silanol group include compounds represented by general formula [8]: 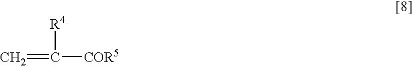
wherein R⁴ represents hydrogen atom or methyl group, and R⁵ represents a halogen atom or a group expressed by any one of the following formulae:

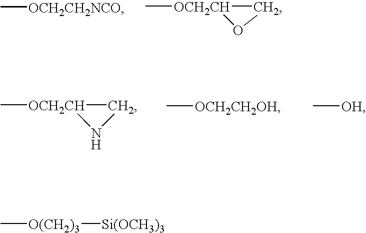

Examples of the above compound include acrylic acid, acrylic chloride, 2-isocyanatoethyl acrylate, glycidyl acrylate, 2,3-iminopropyl acrylate, 2-hydroxyethyl acrylate, acryloyloxypropyltrimethoxysilane and derivatives of methacrylic acid corresponding to the above derivatives of acrylic acid. Acrylic acid, methacrylic acid and the derivatives of these acids may be used singly or in combination of two or more.

The silica sol to which the organic compound having a radical polymerizable unsaturated group and a functional group reactive with the silanol group is bonded is crosslinked and cured by irradiation with an ionizing radiation.

The silica sol exhibits the effect of decreasing the refractive index of the hard coat layer, decreasing shrinkage by curing and shrinkage under heat and moisture of the hard coat film and suppressing curling of the hard coat film due to the shrinkages. It is preferable that the amount of the silica sol is selected, in general, in a range such that the content as silica in the formed hard coat layer is 20 to 60% by weight. When the content is smaller than 20% by weight, there is the possibility that the effect of decreasing the refractive index of the hard coat layer and the effect of suppressing curling of the hard coat film are not sufficiently exhibited. When the content exceeds 60% by weight, the formation of the hard coat layer becomes difficult, and the content causes a decrease in the hardness of the hard coat layer. When the hardness and the refractive index of the hard coat layer, the property for forming the hard coat layer and the effect of suppressing curling of the hard coat film are considered, it is more preferable that the content of silica in the hard coat layer is in the range of 20 to 45% by weight.

The fine particles of silica or a silicone resin having an average particle diameter of about 0.1 to 10 μm may be comprised in the hard coat layer to provide the anti-glare property to the hard coat film. When the diameter of the fine particles of silica or a silicone resin is smaller than 0.1 μm, there is the possibility that effect of providing the anti-glare property is not sufficiently exhibited. When the diameter of the particles exceeds 10 μm, the surface of the hard coat layer becomes rough, and the clarity of vision through tends to decrease. From the standpoint of the balance between the ant-glare property and the clarity of vision through, it is preferable that the average diameter of the fine particles is in the range of 0.5 to 8 μm.

The fine particles of silica are not particularly limited as long as the average particle diameter is within the above range, and various fine particles of silica can be used. Among the various fine particles of silica, fine particles of silica gel are preferable. The fine particles of silica gel comprise SiO₂ as the main component, and the surface thereof may have hydroxyl group (silanol group) or may be modified with an organic group.

The fine particles of a silicone resin are not particularly limited. From the standpoint of the properties, fine particles of polyorganosilsesquioxane having the three dimensionally crbsslinked network having a siloxane bond represented by general formula [9]:
(RSiO_{3/2})ₚ [9]
wherein R represents an organic group, and p represents the degree of polymerization, are preferable.

The fine particles of polyorganosilsesquioxane can be obtained, for example, by polymerizing in a suitable organic solvent an organotrialkoxysilane represented by general formula [10]:
R⁶Si(OR⁷)₃ [10]
wherein R⁶ represents a non-hydrolyzable group which is an alkyl group having 1 to 20 carbon atoms, an alkyl group having 1 to 20 carbon atoms and (meth)acryloyloxy group or epoxy group, an alkenyl group having 2 to 20 carbon atoms, an aryl group having 6 to 20 carbon atoms or an aralkyl group having 7 to 20 carbon atoms, R⁷ represents an alkyl group having 1 to 7 carbon atoms, and three groups represented by OR⁷ may be the same group or different groups.

Examples of the organotrialkoxysilane represented by general formula [10] include methyltrimethoxysilane, methytriethoxysilane, methyltripropoxysilane, methyltriisopropoxysilane, ethyltrimethoxysilane, ethyltriethoxysilane, propyltriethoxysilane, butyltrimethoxysilane, phenyltrimethoxysilane, phenyltriethoxysilane, vinyltrimethoxysilane, vinyltriethoxysilane, γ-glycidoxypropyltrimethoxysilane, γ-acryloyloxy-propyltrimethoxysilane, and γ-methacryloyloxypropyltrimethoxysilane. The organotrialkoxysilane may be used singly or in combination of two or more.

Examples of the organic solvent used for hydrolysis and polycondensation of the organotrialkoxysilane include aromatic hydrocarbons such as benzene, toluene and xylene, esters such as methyl acetate, ethyl acetate and propyl acetate, ketones such as acetone, methyl ethyl ketone, methyl isobutyl ketone and cyclohexanone, and alcohols such as methyl alcohol, ethyl alcohol, n-propyl alcohol, isopropyl alcohol, n-butyl alcohol and isobutyl alcohol.

Examples of the commercial products of the fine particles of the polyorganosilsesquioxane include “X-52 series” products (a trade name) manufactured by SHIN-ETSU KAGAKU KOGYO Co., Ltd.

The fine particles of silica and the fine particles of a silicone resin may be used singly or in combination of two or more. The content in the hard coat layer is selected, in general, in the range of 0.1 to 20% by weight. When the content is smaller than 0.1% by weight, there is the possibility that the effect of providing the anti-glare property is not sufficiently exhibited. When the content exceeds 20% by weight, other physical properties of the hard coat layer are decreased. It is preferable that the content is in the range of 0.5 to 15% by weight.

The aggregate of colloidal fine particles of silica with an amine having an average diameter of about 0.3 to 30 μm may be comprised in the hard coat layer so that the anti-glare property is provided to the hard coat film.

When the average particle diameter of the aggregate is smaller than 0.3 μm, there is the possibility that the effect of providing the anti-glare property is not sufficiently exhibited. When the average particle diameter exceeds 30 μm, the surface of the hard coat layer becomes rough, and the clarity of vision through tends to decrease. From the standpoint of the balance between the anti-glare property and the clarity of vision through, it is preferable that the average particle diameter is in the range of 0.5 to 10 μm.

In the colloidal particles of silica, in general, particles of silica are dispersed uniformly in water or a hydrophilic solvent such as an alcohol. In the present invention, since a solvent containing water is not preferable from the standpoint of the compatibility in the preparation of the resin composition sensitive to an ionizing radiation, a dispersion in a hydrophilic solvent such as an alcohol is preferable. The colloidal particles of silica before the aggregation has, in general, an average diameter in the range of 10 to 20 nm.

The amine compound used for aggregation of the colloidal particles of silica is not particularly limited. For example, a compound can be suitably selected from aliphatic amines, alicyclic amine, aromatic amines and heterocyclic amines. The number of nitrogen atom in the amine compound is not particularly limited. Among the amine compounds, secondary amines and tertiary amines are preferable since these compounds exhibit excellent stability in storage of the resin composition sensitive to an ionizing radiation, the suitable property for aggregation and the suitable rate of aggregation. Among the amine compounds, heterocyclic secondary and tertiary amines are preferable.

The amine compound may be used singly or in combination of two or more. The aggregation of the colloidal silica with the amine compound can be conducted at the time of the preparation of the resin composition sensitive to an ionizing radiation.

The content of the aggregate of colloidal particles of silica with the amine compound in the hard coat layer is selected, in general, in the range of 1 to 30% by weight. When the content is smaller than 1% by weight, there is the possibility that the anti-glare property is not sufficiently exhibited. When the content exceeds 30% by weight, the transmission of light tends to become poor. From the standpoint of the balance between the anti-glare property and the transmission of light, it is preferable that the content is in the range of 3 to 15% by weight.

Fine particles of other metal oxides will be described in the following.

The fine particles of other metal oxide are used for adjusting the refractive index and for improving the antistatic property of the hard coat layer. In combination with the silica-based fine particles used for providing the anti-glare property, the fine particles of other metal oxide are used for retaining the excellent anti-glare property provided by the silica-based fine particles and for suppressing the decrease in the quality of displayed images by improving the clarity of transmission.

As the fine particles of other metal oxides, particles having an average diameter of about 1 to 60 nm are used. When the average diameter of the fine particles is outside the above range, it is difficult that the above effects are sufficiently exhibited. From the standpoint of the effects, it is preferable that the average diameter of the fine particles is in the range of 5 to 50 nm and more preferably in the range of 10 to 30 nm.

The metal oxide in the fine particles of other metal oxides may be a composite oxide comprising two or more metals or an oxide comprising a single metal. As the fine particles of other metal oxides, for example, fine particles of a single metal oxide such as Al₂O₃, TiO₂, Fe₂O₃, ZnO, CeO₂, Y₂O₃, MgO, ZrO₂, PbO, SnO₂, Ho₂O₃, SrO, Bi₂O₃, Nd₂O₃, Sb₂O₃, In₂O₃ and Yb₂O₃ or a composite metal oxide such as Al₂O₃/MgO, BaTiO₃, Y₂O₃/Eu and zinc antimonate, can be used. Among these fine particles, fine particles of zinc antimonate are preferable. The fine particles of zinc antimonate are provided in the form of a sol as a commercial product such as “CELNAX series” products manufactured by NISSAN KAGAKU KOGYO Co., Ltd. and easily available. The fine particles of other metal oxides may be used singly or in combination of two or more.

The content of the above fine particles of other metal oxides in the hard coat layer is selected, in general, in the range of 5 to 60% by weight. When the content is smaller than 5% by weight, it is difficult that the effect of adding the fine particles of other metal oxides is exhibited. When the content exceeds 60% by weight, there is the possibility that transparency and hardness decrease, and formation of the hard coat layer becomes difficult. It is preferable that the content of the fine particles of other metal oxides is in the range of 10 to 50% by weight and more preferably in the range of 20 to 45% by weight.

The hard coat layer in the hard coat film of the present invention can be prepared by coating at least one face of the transparent substrate material film described above with the resin composition sensitive to an ionizing radiation which comprises a resin component curable with an ionizing radiation and the polymerizable surfactant and, where necessary, the fine particles described above and a photopolymerization initiator to form a coating film, and then curing the formed coating film by irradiation with an ionizing radiation.

The resin composition sensitive to an ionizing radiation is a resin composition which is crosslinked and cured by irradiation with an electromagnetic wave or beams of charged particles having energy quantum, i.e., ultraviolet light or electron beams, among electromagnetic waves and beams of charged particles.

In the resin composition sensitive to an ionizing radiation described above, for example, photopolymerizable prepolymers and/or photopolymerizable monomers can be used as the resin component curable with an ionizing radiation. The photopolymerizable prepolymer includes prepolymers of the radical polymerization type and prepolymers of the cationic polymerization type. Examples of the photopolymerizable prepolymer of the radical polymerization type include polyester acrylate-based prepolymers, epoxy acrylate-based prepolymers, urethane acrylate-based prepolymers and polyol acrylate-based prepolymers. The polyester acrylate-based prepolymer can be obtained, for example, by obtaining a polyester oligomer having hydroxyl groups at both ends by condensation of a polyfunctional carboxylic acid with a polyhydric alcohol, followed by esterification of the hydroxyl groups in the obtained oligomer with (meth)acrylic acid; or by obtaining an oligomer having hydroxyl groups at both ends by addition of an alkylene oxide to a polyfunctional carboxylic acid, followed by esterification of the hydroxyl groups of the obtained oligomer- with (meth)acrylic acid. The epoxy acrylate-based prepolymer can be obtained, for example, by esterification of oxirane rings in an epoxy resin of a bisphenol type or a novolak type having a relatively low molecular weight by the reaction with (meth)acrylic acid. The urethane acrylate-based prepolymer can be obtained, for example, by the reaction of a polyether polyol or a polyester polyol with a polyisocyanate to obtain a polyurethane oligomer, followed by esterification of the obtained polyurethane oligomer with (meth)acrylic acid. The polyol acrylate-based prepolymer can be obtained, for example, by esterification of hydroxyl groups in a polyether polyol with (meth)acrylic acid. The above photopolymerizable prepolymers may be used singly or in combination of two or more.

As the photopolymerizable prepolymer of the cationic polymerization type, in general, epoxy-based resins are used. Examples of the epoxy-based resin include compounds obtained epoxidation of polyhydric phenols such as bisphenol resins and novolak resins with epichlorohydrin and compounds obtained by oxidation of linear olefin compounds and cyclic olefin compounds with peroxides.

As the photopolymerizable monomer, for example, polyfunctional (meth)acrylate-based monomers such as 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, dicyclopentenyl di(meth)acrylate modified with caprolactone, phosphoric acid di(meth)acrylate modified with ethylene oxide, cyclohexyl di(meth)acrylate modified with allyl group, isocyanurate di(meth)acrylate, trimethylolpropane tri(meth)acrylate, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide, tris(acryloxyethyl) isocyanurate, dipentaerythritol penta(meth)-acrylate modified with propionic acid, dipentaerythritol hexa(meth)acrylate and dipentaerythritol hexa(meth)acrylate modified with caprolactone, are preferable. The photopolymerizable monomer may be used singly, in combination of two or more or in combination with the photopolymerizable prepolymer described above.

As the photopolymerization initiator, one or more compounds can be suitably selected as desired from conventional photopolymerization initiators used for the radical polymerization. Examples of the conventional photopolymerization initiator include aryl ketone photopolymerization initiators such as acetophenones, benzophenones, alkylaminobenzophenones, benzyls, benzoins, benzoin ethers, benzyl dimethyl acetals, benzoyl benzoates and α-acyloxime esters; photo-polymerization initiators having sulfur such as sulfides and thioxanthones; acylphosphine oxides such as acyl diaryl phosphine oxides; anthraquinones; and other photopolymerization initiators. Examples of the photopolymerization initiator which is used for the photopolymerizable prepolymers of the cationic polymerization type include compounds comprising an onium such as an aromatic sulfonium ion, an aromatic oxosulfonium ion and an aromatic iodonium ions and an anion such as tetrafluoroborate anion, hexafluorophosphate anion, hexafluoroantimonate anion and hexafluoroarsenate anion. The photopolymerization initiator may be used singly or in combination of two or more. The amount of the photopolymerization initiator is selected, in general, in the range of 0.2 to 10 parts by weight and preferably in the range of 0.5 to 7 parts by weight per 100 parts by weight of the entire components curable with light.

When the curing is conducted by irradiation with electron beams, it is not necessary that the photopolymerization initiator is used.

Where desired, the resin composition sensitive to an ionizing radiation of the present invention may further comprise various additional components such as monofunctional acrylate-based monomers, photosensitizers, polymerization inhibitors, crosslinking agents, antioxidants, ultraviolet light absorbents, photostabilizers, leveling agents and defoaming agents as long as the object of the present invention is not adversely affected.

As the monofunctional acrylate-based monomer, for example, at least one compound can be suitably selected from cyclohexyl (meth)acrylate, 2-ethylhexyl (meth)acrylate, lauryl (meth)acrylate, stearyl (meth)acrylate and isobornyl (meth)acrylate. The monofunctional acrylate-based monomer is a resin component curable with light.

As the photosensitizer, for example, tertiary amines, p-dimethylaminobenzoic acid esters and thiol-based sensitizers can be used. When the curing is conducted by irradiation with electron beams, it is not necessary that the photopolymerization sensitizer is used.

The content of the photosensitizer is selected, in general, in the range of 1 to 20 parts by weight and preferably in the range of 2 to 10 parts by weight per 100 parts by weight of the entire components curable with light.

As the antioxidant, the ultraviolet light absorbent and the photostabilizer, suitable compounds can be selected from the conventionally used antioxidants, ultraviolet light absorbents and photostabilizers. In particular, it is advantageous that antioxidants, ultraviolet light absorbents and photostabilizers of the reactive type having (meth)acryloyl group in the molecule are used. When these compounds are used, components of the antioxidant, the ultraviolet light absorbent and the photostabilizer are bonded to the polymer chain formed by the irradiation with the ionizing radiation. Therefore, dissipation of the components from the cured layer with time is suppressed, and the functions of the components are exhibited for a long period of time.

The resin composition sensitive to an ionizing radiation used in the present invention can be prepared by mixing the resin component curable by irradiation with an ionizing radiation and the polymerizable surfactant which are described above and the fine particles, the photopolymerization initiator and various additives which are described above and used where desired in amounts prescribed for each component in a solvent which is used where necessary, followed by dissolving or dispersing the components.

Examples of the solvent used above include aliphatic hydrocarbons such as hexane, heptane and cyclohexane; aromatic hydrocarbons such as toluene and xylene; halogenated hydrocarbons such as methylene chloride and ethylene chloride; alcohols such as methanol, ethanol, propanol, butanol and 1-methoxy-2-propanol; ketones such as acetone, methyl ethyl ketone, 2-pentanone, isophorone and cyclohexanone; esters such as ethyl acetate and butyl acetate; and cellosolve solvents such as ethyl cellosolve.

The concentration and the viscosity of the prepared resin composition are not particularly limited as long as the resin composition can be used for coating and can be suitably selected in accordance with the situation.

At least one face of the transparent substrate material film described above is coated with the above resin composition in accordance with a conventional process such as the bar coating process, the knife coating process, the roll coating process, the blade coating process, the die coating process and the gravure coating process to form a coating film. After the formed film is dried, the hard coat layer is formed by curing the coating film by irradiation with an ionizing radiation.

As the ionizing radiation, for example, ultraviolet light or electron beams are used. The ultraviolet light can be obtained from a high pressure mercury lamp, a fusion H lamp or a xenon lamp. The amount of the light used for the irradiation is, in general, in the range of 100 to 500 mJ/cm². Electron beams can be obtained from an electron accelerator. The amount of the beams used for the irradiation is, in general, in the range of 150 to 350 kV. Between these ionizing radiations, ultraviolet light is preferable. When the electron beams are used, the cured film can be obtained without adding a polymerization initiator.

It is preferable that the thickness of the hard coat layer formed as described above is in the range of 0.5 to 30 μm. When the thickness is smaller than 0.5 μm, there is the possibility that the hardness of the surface of the hard coat film is insufficient, and the scratch resistance is not sufficiently exhibited. When the thickness exceeds 30 μm, there is the possibility that shrinkage by curing and shrinkage under heat and moisture increase. In this case, the hard coat film tends to be curled, and cracks are occasionally formed in the hard coat film. Thus, the thickness greater than the above range is disadvantageous with respect to the productivity. It is more preferable that the thickness of the hard coat layer is in the range of 1 to 20 μm and most preferably in the range of 2 to 15 μm.

It is preferable that the hard coat layer in the hard coat film of the present invention has a hardness of H or higher expressed as the pencil hardness. The scratch resistance sufficient for the hard coat film can be provided when the pencil hardness is H or higher. It is more preferable that the hard coat layer has a pencil hardness of 2H or higher so that the scratch resistance is more sufficiently exhibited. The method of measurement of the pencil hardness will be described later. The haze value of the hard coat film is, in general, 20% or smaller and preferably 10% or smaller.

When the hard coat layer is formed on one face alone of the transparent substrate material film in the hard coat film of the present invention, an adhesive layer for adhering the hard coat film to an adherend may be formed on the face of the transparent substrate material film opposite to the face having the hard coat layer. As the adhesive constituting the adhesive layer, an adhesive for optical applications such as an acrylic adhesive, a urethane-based adhesive and a silicone-based adhesive is preferable. The thickness of the adhesive layer is, in general, in the range of 5 to 100 μm and preferably in the range of 10 to 60 μm.

A release film may be disposed on the adhesive layer, where necessary. Examples of the release film include release films prepared by coating paper such as glassine paper, coated paper and laminate paper or a plastic film with a release agent such as a silicone resin. The thickness of the release film is not particularly limited. In general, the thickness of the release film is in the range of 20 to 150 μm.

To summarize the advantages obtained by the invention, the hard coat film exhibits excellent scratch resistance and wear resistance, provides the property for preventing attachment of finger prints and the property for removal of finger prints by a simple operation, is excellent in retaining these properties, exhibits excellent solvent resistance and is advantageously used as the hard coat film for touch panels and the hard coat film for protecting various types of display.

### EXAMPLES

The present invention will be described more specifically with reference to examples in the following. However, the present invention is not limited to the examples.

The properties of a hard coat film were evaluated in accordance with the following methods.
(1) The total light transmittance (Tt) and the haze value were measured in accordance with the methods of Japanese Industrial Standard K7361-1 and K7136, respectively, using a haze meter [manufactured by NIPPON DENSHOKU KOGYO Co., Ltd.; NDH2000].
(2) The contact angle was measured in accordance with the liquid drop method using a contact angle meter [manufactured by KYOWA KAIMEN KAGAKU Co., Ltd.; the type: “CA-D”]. A liquid drop of purified water (a diameter of 2 mm) was placed on the surface of a hard coat layer, and the contact angle between the surface of the hard coat layer and the purified water was measured.
(3) The property for preventing attachment of finger prints was evaluated as follows: a hard coat film for the evaluation was placed on a black plate in a manner such that the hard coat layer was placed upwards; a finger was pressed slowly to the surface of the hard coat layer; and it was examined whether the attached finger print was found by the visual observation or not. This examination was conducted by randomly chosen 10 persons. The property for preventing attachment of finger prints was evaluated by the number of persons whose finger print was not found by the visual observation, the maximum point being 10. Although the tendency for attachment of finger prints may be different depending on the person, the above test can be considered to show the average tendency for attachment of finger prints since the ten persons were randomly chosen.
(4) The property for wiping out finger prints was evaluated only when the attached finger print was found by the visual observation in the test of the property for preventing attachment of finger prints. Ten persons each wiped the surface having the visible finger print lightly 5 times with cotton stockinet cloth wrapped around a finger tip of the person, and the property for wiping out finger prints was evaluated by visual observation in accordance with the following criterion: A: the finger print was completely wiped out; B: the finger print slightly remained; C: the finger print remained. In Examples and Comparative Examples, the number of persons giving each of A, B and C among the ten persons is shown. When no attached finger prints were found in the test of the property for preventing attachment of finger prints, the property for wiping out finger prints was evaluated as A10.
(5) Solvent resistance

The surface of the hard coat layer of a hard coat film for the test was strongly rubbed with a cotton stockinet cloth impregnated with alcohol. After the surface was dried to remove alcohol, the rubbed portion of the surface was observed directly under a fluorescence lamp of three wavelengths using the reflected light. It was examined whether the rubbed portion was whitened or not, and the solvent resistance was evaluated based on the result.
(6) The pencil hardness was measured in accordance with the method of Japanese Industrial Standard K5600 using a hardness tester of a coating film by pencil scratch [manufactured by TOYO SEIKI SEISAKUSHO Co., Ltd.; the type: “NP”].
(7) Heat resistance

The heat resistance of a hard coat film was evaluated in accordance with the same procedures as those described above in (3) after the hard coat film for the test was left standing under an environment of 150° C. for 90 minutes.

### Example 1

To 100 parts by weight of a urethane acrylate-based hard coating material curable with ultraviolet light [manufactured by ARAKAWA KAGAKU KOGYO Co., Ltd.; “BEAMSET 575CB”; the concentration of solid components: 100%; containing a photopolymerization initiator] as the resin curable with an ionizing radiation, 3 parts by weight of a sulfuric acid ester salt of a polyoxyethylene alkylphenyl ether [manufactured by DAIICHI KOGYO SEIYAKU Co., Ltd.; the trade name: “AQUALON HS-20] as the radical polymerizable anionic surfactant was added. The resultant mixture was diluted with a mixed solvent containing cyclohexane and ethylcellosolve in relative amounts by weight of 1:1 so that the concentration of the solid components in the obtained entire mixture was adjusted at 45% by weight, and a resin composition sensitive to an ionizing radiation was prepared.

The prepared resin composition was applied to the adhesive face of a polyethylene terephthalate film having one face treated for easy adhesion and a thickness of 188 μm [manufactured by TOYO BOSEKI Co., Ltd.; A4100] as the transparent substrate material film using a Mayer bar No. 8. After the formed coating layer was dried at 70° C. for 1 minute, the dried coating layer was cured by irradiation with ultraviolet light in an amount of light of 250 mJ/cm², and a cured hard coat layer was formed. The cured hard coat layer had a thickness of 4.5 μm.

The results of the evaluations of the prepared hard coat film are shown in Table 1.

### Example 2

A hard coat film was prepared in accordance with the same procedures as those conducted in Example 1 except that a polyoxyethylene alkylphenyl ether [manufactured by DAIICHI KOGYO SEIYAKU Co., Ltd.; the trade name: “AQUALON RN-10”; (HLB: 12.6)] which was a radical polymerizable nonionic surfactant was used in place of the radical polymerizable anionic surfactant used in Example 1.

The results of evaluation of the properties of the prepared hard coat film are shown in Table 1.

### Example 3

A hard coat film was prepared in accordance with the same procedures as those conducted in Example 1 except that 3 parts by weight of particles of silica gel having an average diameter of 1.4 μm [manufactured by FUJI SILYSIA KAGAKU Co., Ltd.; the trade name: SILYSIA 310”] was further added to prepare a resin composition sensitive to an ionizing radiation.

The results of evaluation of the properties of the prepared hard coat film are shown in Table 1.

### Example 4

A hard coat film was prepared in accordance with the same procedures as those conducted in Example 2 except that 3 parts by weight of particles of silica gel having an average diameter of 1.4 mm [manufactured by FUJI SILYSIA KAGAKU Co., Ltd.; the trade name: SILYSIA 310”] was further added to prepare a resin composition sensitive to an ionizing radiation.

The results of evaluation of the properties of the prepared hard coat film are shown in Table 1.

### Example 5

A hard coat film was prepared in accordance with the same procedures as those conducted in Example 1 except that the amount of the radical polymerizable anionic surfactant was changed to 6 parts by weight.

The results of evaluation of the properties of the prepared hard coat film are shown in Table 1.

### Comparative Example 1

A hard coat film was prepared in accordance with the same procedures as those conducted in Example 1 except that 0.1 part by weight of a leveling agent having the dimethylsiloxane skeleton structure [manufactured by TORAY DOW CORNING SILICONE Co., Ltd.; the trade name: “SH28PA”] was used in place of the radical polymerizable anionic surfactant used in Example 1.

The results of evaluation of the properties of the prepared hard coat film are shown in Table 1.

### Comparative Example 2

A hard coat film was prepared in accordance with the same procedures as those conducted in Example 1 except that the radical polymerizable anionic surfactant was not used.

The results of evaluation of the properties of the prepared hard coat film are shown in Table 1.

### Comparative Example 3

A hard coat film was prepared in accordance with the same procedures as those conducted in Example 3 except that a leveling agent having the dimethylsiloxane skeleton structure [manufactured by TORAY DOW CORNING SILICONE Co., Ltd.; the trade name: “SH28PA”] was used in place of the radical polymerizable anionic surfactant used in Example 3.

The results of evaluation of the properties of the prepared hard coat film are shown in Table 1.

### Comparative Example 4

A hard coat film was prepared in accordance with the same procedures as those conducted in Example 3 except that 0.1 part by weight of a fluorine-based additive [manufactured by NIPPON YUSHI Co., Ltd.; the trade name: “MODIPER F-200”] was used in place of the radical polymerizable anionic surfactant used in Example 3.

The results of evaluation of the properties of the prepared hard coat film are shown in Table 1.

TABLE 1-1

| | Example | | | | |
|---|---|---|---|---|---|
| Properties of hard coat film | 1 | 2 | 3 | 4 | 5 |
| Tt(%) | 91.3 | 91.4 | 90.1 | 90.2 | 91.0 |
| haze value (%) | 0.8 | 0.7 | 4.2 | 4.8 | 0.8 |
| contact angle of water (degree) | 69.8 | 70.4 | 69.5 | 69.3 | 69.0 |
| property for preventing | 8 | 7 | 10 | 10 | 9 |
| attachment of finger prints | | | | | |
| property for wiping out finger | A10 | A10 | — | — | A10 |
| prints | | | | | |
| solvent resistance (change in | none | none | none | none | none |
| appearance) | | | | | |
| pencil hardness | 3H | 3H | 3H | 3H | 3H |
| heat resistance (prevention of | 8 | 7 | 10 | 10 | 9 |
| attachment of finger prints) | | | | | |

(In Examples 3 and 4, the test of wiping out finger prints was not conducted since the property for preventing attachment of finger prints was evaluated as 10.)

TABLE 1-2

| | Comparative Example | | | |
|---|---|---|---|---|
| Properties of hard coat film | 1 | 2 | 3 | 4 |
| Tt(%) | 90.9 | 90.5 | 90.2 | 90.5 |
| haze value (%) | 0.8 | 0.9 | 4.0 | 4.8 |
| contact angle of water (degree) | 84.3 | 70.1 | 70.9 | 79.5 |
| property for preventing | 0 | 2 | 3 | 4 |
| attachment of finger prints | | | | |
| property for wiping out finger | A0 | A0 | A0 | A0 |
| prints | B1 | B2 | B3 | B4 |
| | C9 | C8 | C7 | C6 |
| solvent resistance (change in | found | found | found | found |
| appearance) | | | | |
| pencil hardness | 3H | 3H | 2H | 2H |
| heat resistance (prevention of | 0 | 2 | 3 | 4 |
| attachment of finger prints) | | | | |

As clearly shown in Table 1, the hard coat films of the present invention (Examples 1 to 5) all had a pencil hardness of 3H and exhibited excellent results in the properties as the hard coat film, the property for preventing attachment of finger prints, the property for wiping out finger prints and the solvent resistance. In contrast, the hard coat films of Comparative Example 1 to 4 all exhibited inferior results in the property for preventing attachment of finger prints, the property for wiping out finger prints and the solvent resistance.

1. A hard coat film comprising a transparent substrate material film and a hard coat layer disposed at least on one face of the substrate material film, wherein the hard coat layer comprises a cured product of a resin composition sensitive to an ionizing radiation which comprises a resin component curable with an ionizing radiation and a polymerizable surfactant.

2. The hard coat film according to claim 1, wherein the polymerizable surfactant is at least one surfactant selected from the group consisting of an anionic surfactant and an nonionic surfactant, each surfactant having a radical polymerizable functional group in a molecule.

3. The hard coat film according to claim 1, wherein the resin component curable with an ionizing radiation is at least one compound selected from the group consisting of (a) at least one photopolymerizable prepolymer selected from the group consisting of (i) at least one photopolymerizable prepolymer of radical polymerization type selected from the group consisting of polyester acrylate-based prepolymers, epoxy acrylate-based prepolymers, urethane acrylate-based prepolymers and polyol acrylate-based prepolymers and (ii) at least one photopolymerizable prepolymer of cationic polymerization type of an epoxy-based resin selected from the group consisting of a compound obtained by epoxidation of polyhydric phenols selected from the group consisting of a bisphenol resins and a novolak resin with epichlorohydrin and a compound obtained by oxidation of a linear olefin compound or a cyclic olefin compound with peroxide and
(b) at least one photopolymerizable polyfunctional (meth)acrylate-based monomer selected from the group consisting of 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, dicyclopentenyl di(meth)acrylate modified with caprolactone, phosphoric acid di(meth)acrylate modified with ethylene oxide, cyclohexyl di(meth)acrylate modified with allyl group, isocyanurate di(meth)acrylate, trimethylolpropane tri(meth)acrylate, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide, tris(acryloxyethyl) isocyanurate, dipentaerythritol penta(meth) acrylate modified with propionic acid, dipentaerythritol hexa(meth)acrylate and dipentaerythritol hexa(meth)acrylate modified with caprolactone.

4. The hard coat film according to claim 3, which further comprises a photopolymerization initiator in a range of 0.2 to 10 parts by weight per 100 parts by weight of entire components curable with light in the hard coat layer.

5. The hard coat film according to claim 2, wherein the polymerizable surfactant is an anionic surfactant comprising a sulfuric acid ester salt.

6. The hard coat film according to claim 5, wherein the sulfuric acid salt is at least one salt selected from the group consisting of a compound represented by formulae [1], [2] and [4]: 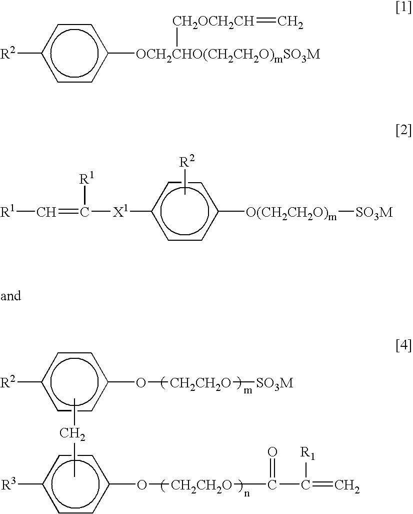
wherein R¹ represents a hydrogen atom or a methyl group, R² and R³ each represent an alkyl group, an alkenyl group, an aryl group or an aralkyl group each having 6 to 18 carbon atoms, X¹ represents a single bond or a methylene group, M represents an alkali metal, ammonium group or an organic ammonium group, and m and n each represent an integer of 1 to 50.

7. The hard coat film according to claim 6, wherein the sulfuric acid salt is a compound represented by formula [2]: 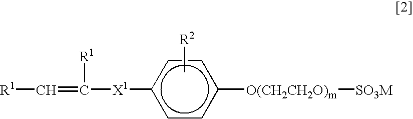
wherein R¹ represents hydrogen a atom or a methyl group, R² represents an alkyl group, an alkenyl group, an aryl group or an aralkyl group each having 6 to 18 carbon atoms, X¹ represents a single bond or a methylene group, M represents an alkali metal, ammonium group or an organic ammonium group, and m represents an integer of 1 to 50.

8. The hard coat film according to claim 4, wherein the polymerizable surfactant is an anionic surfactant comprising a sulfuric acid ester salt represented by formula [2]: 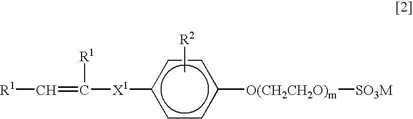
wherein R¹ represents a hydrogen atom or a methyl group, R² represents an alkyl group, an alkenyl group, an aryl group or an aralkyl group each having 6 to 18 carbon atoms, X¹ represents a single bond or a methylene group, M represents an alkali metal, ammonium group or an organic ammonium group, and m represents an integer of 1 to 50.

9. The hard coat film according to claim 1, wherein a content of the polymerizable surfactant in the resin composition sensitive to an ionizing 9. The hard coat film according to claim 1, wherein a content of the polymerizable surfactant in the resin composition sensitive to an ionizing radiation is 0.1 to 15 parts by weight per 100 parts by weight of the resin component curable with an ionizing radiation.

10. The hard coat film according to claim 2, wherein a content of the polymerizable surfactant in the resin composition sensitive to an ionizing radiation is 0.1 to 15 parts by weight per 100 parts by weight of the resin component curable with an ionizing radiation.

11. The hard coat film according to claim 8, wherein a content of the polymerizable surfactant in the resin composition sensitive to an ionizing radiation is 0.1 to 15 parts by weight per 100 parts by weight of the resin component curable with an ionizing radiation.

12. The hard coat film according to claim 1, wherein the hard coat layer further comprises 0.1 to 60% by weight of fine particles having an average diameter of 0.005 to 30 μm.

13. The hard coat film according to claim 2, wherein the hard coat layer further comprises 0.1 to 60% by weight of fine particles having an average diameter of 0.005 to 30 μm.

14. The hard coat film according to claim 11, wherein the hard coat layer further comprises 0.1 to 60% by weight of fine particles having an average diameter of 0.005 to 30 μm.

15. The hard coat film according to claim 12, wherein the fine particles are at least one particles selected from the group consisting of
(a) at least one silica based fine particles selected from the group consisting of (i) a silica sol having an average diameter of about 0.005 to 1 μm, (ii) fine particles of silica or fine particles of silicone resins having an average diameter of about 0.1 to 10 μm, and (iii) aggregates of colloidal fine particles of silica with an amine having an average diameter of about 0.3 to 30 μm; and
(b) at least one metal oxide based particles having an average diameter of about 1 to 60 nm, said metal based particles being selected from the group consisting of (i) fine particles of a single metal oxide selected from the group consisting of Al₂O₃, TiO₂, Fe₂O₃, ZnO, CeO₂, Y₂O₃, MgO, ZrO₂, PbO, SnO₂, Ho₂O₃, SrO, Bi₂O₃, Nd₂O₃, Sb₂O₃, In₂O₃ and Yb₂O₃ and (ii) a composite metal oxide selected from the group consisting of Al₂O₃/MgO, BaTiO₃, Y₂O₃/Eu and zinc antimonate.

16. The hard coat film according to claim 15, wherein the fine particles are fine powders of silica gel.

17. A touch panel which comprises the hard coat film of claim 1.

18. A touch panel which comprises the hard coat film of claim 16.

19. A touch panel which comprises the hard coat film of claim 17.
